(19) United States
(12) Patent Application Publication
(10) Pub. No.: US 2023/0012955 A1
(43) Pub. Date: Jan. 19, 2023

(54) PROJECTION DEVICE

(71) Applicant: IVIEW DISPLAYS (SHENZHEN) COMPANY LTD., Shenzhen (CN)

(72) Inventors: Mingnei Ding, Shenzhen (CN); Steve Yeung, Hong Kong (CN); Zhiqiang Gao, Hong Kong (CN); Xiang Li, Shenzhen (CN)

(21) Appl. No.: 17/700,630

(22) Filed: Mar. 22, 2022

Related U.S. Application Data
(63) Continuation of application No. PCT/CN2021/114585, filed on Aug. 25, 2021.

(30) Foreign Application Priority Data
Jul. 8, 2021 (CN) 202110773399.7

(51) Int. Cl. G03B 21/14; G03B 21/28

(52) U.S. Cl. CPC G03B 21/142; G03B 21/28

(57) ABSTRACT

The present disclosure, relating to the technical field of projection and display, provides a projection device. The projection device includes: a projecting unit, configured to emit a projection screen; a direction adjusting unit; a reflecting unit, fixed to the direction adjusting unit, wherein the direction adjusting unit is configured to adjust a reflection direction of the reflecting unit; and a height adjusting unit, wherein one end of the height adjusting unit is connected to the projecting unit and the other end of the height adjusting unit is connected to the direction adjusting unit, the height adjusting unit is configured to adjust a spacing between the reflecting unit and the projecting unit, and the reflecting unit is configured to reflect the projection screen emitted by the projecting unit. With such configurations according to the embodiments of the present disclosure, a height of the projection screen is adjusted by adjusting a spacing between the reflecting unit and the projecting unit.

### CROSS-REFERENCE TO RELATED APPLICATION

This application is based upon and claims priority to Chinese Patent Application No. 202110773399.7, filed before China National Intellectual Property Administration on Jul. 8, 2021 and entitled “PROJECTION DEVICE,” the entire contents of which are incorporated herein by reference.

### TECHNICAL FIELD

Embodiments of the present disclosure relate to the technical field of projection and display, and in particular, relate to a projection device.

### BACKGROUND

The projector is such a device that can project images or videos onto a curtain, and is widely used in scenarios of homes, offices, schools, and recreation places. With the rapid developments of science and technology, projection technologies have got rapid development, and varieties of small-size and high-performance portable projectors have been placed into the market. At present, motion-based projection applicable to various application scenarios, such as families, large-scale stages, has received wide attention. A motion-based projection device needs to multi-directionally project images according to a user instruction, and needs to be synchronized with projection content, such that an immersive experience is created by the motion-based projection device for a user by combining motion with content.

During practice of the present disclosure, the inventors have found that at present, a height of a projection screen of the projection device in the conventional motion-based projection solution is mostly fixed and unadjustable. In the case that a user adjusts a pitch angle of the projection device to reach a suitable projection height, the projection screen has a tilt angle, such that a projection effect is weaken and the user's immersive experience is degraded. Therefore, generally, the user may reach a more suitable projection height only by placing articles under the projector to raise the projector. However, with this method, the projection device fails to be installed stably, and the height fails to be adjusted accurately.

### SUMMARY

With respect to the above defects in the related art, embodiments of the present disclosure are intended to provide a projection device, which is capable of conveniently and accurately adjusting a height of a projection screen.

To solve the above technical problem, the embodiments of the present disclosure provide the following technical solutions:

The embodiments of the present disclosure provide a projection device. The projection device includes: a projecting unit, configured to emit a projection screen; a direction adjusting unit; a reflecting unit, fixed to the direction adjusting unit, wherein the direction adjusting unit is configured to adjust a reflection direction of the reflecting unit; and a height adjusting unit, wherein one end of the height adjusting unit is connected to the projecting unit and the other end of the height adjusting unit is connected to the direction adjusting unit, the height adjusting unit is configured to adjust a spacing between the reflecting unit and the projecting unit, and the reflecting unit is configured to reflect the projection screen emitted by the projecting unit.

Optionally, the height adjusting unit includes a first adjusting frame, a second adjusting frame, a support frame, and a first motor; wherein the first adjusting frame is provided with a groove, the groove being configured to receive the second adjusting frame, the second adjusting frame is movable relative to the first adjusting frame, the first adjusting frame is connected to the projecting unit, the second adjusting frame is connected to the support frame, the support frame is connected to the direction adjusting unit, the first adjusting frame is provided with a gear, the gear being rotatable relative to the first adjusting frame, the second adjusting frame is provided with a rack, the rack being movable along a lengthwise direction of the first adjusting frame, the gear being in mesh with the rack, the first motor is disposed on the first adjusting frame, and the first motor is configured to drive the gear to rotate.

Optionally, the height adjusting unit further includes a fixing assembly, and the first adjusting frame is provided with a through hole; wherein the through hole is in communication with the groove, and the fixing assembly is inserted into the through hole and is abutted against an outer surface of the second adjusting frame.

Optionally, the fixing assembly includes a fixing threaded rod, a fixing block, and an anti-skid pad; wherein the fixing threaded rod is provided with an insertion portion, the insertion portion being inserted into the through hole, the fixing threaded rod is provided with a connection portion, the fixing block is movably connected to the fixing threaded rod via the connection portion, the fixing block is tightly abutted against the anti-skid pad, and the anti-skid pad is tightly abutted against the outer surface of the second adjusting frame.

Optionally, the rack is fixed to an inner surface of the second adjusting frame via at least one screw.

Optionally, a first bump and a second bump are respectively disposed on two ends of the rack, and a first limiting block and a second limiting block are extended on the first adjusting frame towards an interior of the groove; wherein the first limiting block and the second limiting block are spaced apart from each other, the first limiting block and the second limiting block are disposed on two sides of the rack, the first bump is abutted against the first limiting block in the case that an inward retract stroke of the rack reaches a maximum value, and the second bump is abutted against the second limiting block in the case that an extend stroke of the rack reaches a maximum value.

Optionally, the first adjusting frame is provided with a rotation shaft; wherein a gear shaft of the gear is inserted into the rotation shaft, the gear shaft of the gear is fixed to the rotation shaft, and the rotation shaft is connected to the first motor.

Optionally, at least one elastic member is disposed at a lower end of the second adjusting frame.

Optionally, the direction adjusting unit includes: a first rotation assembly, fixed to the other end of the height adjusting unit; and a second rotation assembly, fixed to the first rotation assembly, wherein the reflecting unit is fixed to the second rotation assembly, the first rotation assembly is configured to drive the second rotation assembly to rotate in a first direction, and the second rotation assembly is configured to drive the reflecting unit to rotate in a second direction, the first direction being different from the second direction.

The embodiments of the present disclosure provide the projection device. The projection device includes: the projecting unit, the direction adjusting unit, and the reflecting unit. The projecting unit is configured to emit a projection screen; the reflecting unit is configured to reflect the projection screen, and the reflecting unit is fixed to the direction adjusting unit; the direction adjusting unit is configured to adjust a reflection direction of the reflecting unit; and the height adjusting unit, wherein one end of the height adjusting unit is connected to the projecting unit and the other end of the height adjusting unit is connected to the direction adjusting unit, a spacing between the reflecting unit and the projecting unit may be changed by changing a length of the height adjusting unit, thereby conveniently and accurately adjusting the height of the projection screen.

### BRIEF DESCRIPTION OF THE DRAWINGS

One or more embodiments are illustrated by way of example, and not by limitation, in the figures of the accompanying drawings, wherein elements/modules and steps having the same reference numeral designations represent like elements/modules and steps throughout. The drawings are not to scale, unless otherwise disclosed.

FIG. 1 is a schematic structural view of a projection device according to an embodiment of the present disclosure;

FIG. 2 is a top view of the projection device according to an embodiment of the present disclosure;

FIG. 3 is a sectional view of a height adjusting unit in the projection device in FIG. 1; and

FIG. 4 is an exploded view of a direction adjusting unit and a reflecting unit in the projection device in FIG. 1.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

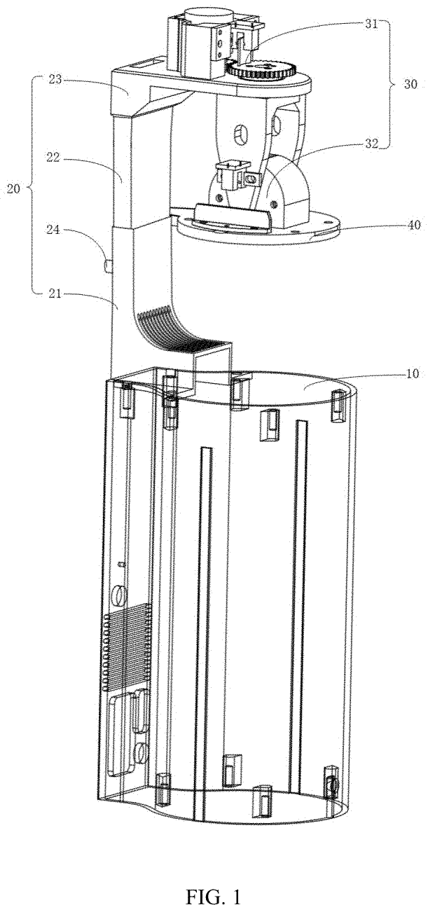

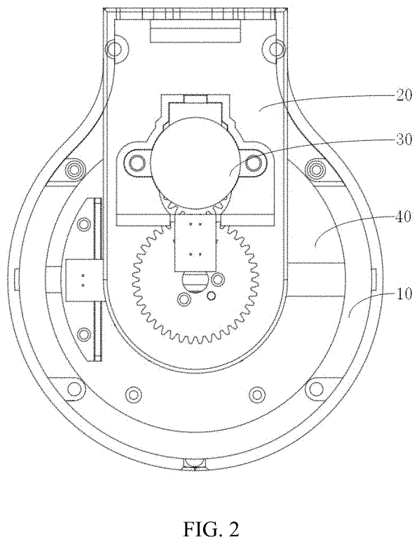

An embodiment of the present disclosure provides a projection device 1. Referring to FIG. 1 and FIG. 2, the projection device 1 includes a projecting unit 10, a height adjusting unit 20, a direction adjusting unit 30, and a reflecting unit 40. One end of the height adjusting unit 20 is connected to the projecting unit 10 and the other end of the height adjusting unit 20 is connected to the direction adjusting unit 30. The reflecting unit 40 is fixed to the direction adjusting unit 30, and the direction adjusting unit 30 is configured to adjust an angle of the reflecting unit 40. The projecting unit 10 is disposed opposite to the reflecting unit 40, and the projecting unit 10 is configured to emit a projection screen. The reflecting unit 40 is configured to reflect the projection screen emitted by the projecting unit 10. The height adjusting unit 20 is configured to adjust a spacing between the reflecting unit 40 and the projecting unit 10, such that a height of the reflecting unit 40 relative to the projecting unit 10 is adjusted, and thus a projection height is adjusted.

With respect to the projection unit 10, the projection unit 10 may be received in an aluminum alloy housing to facilitate heat dissipation.

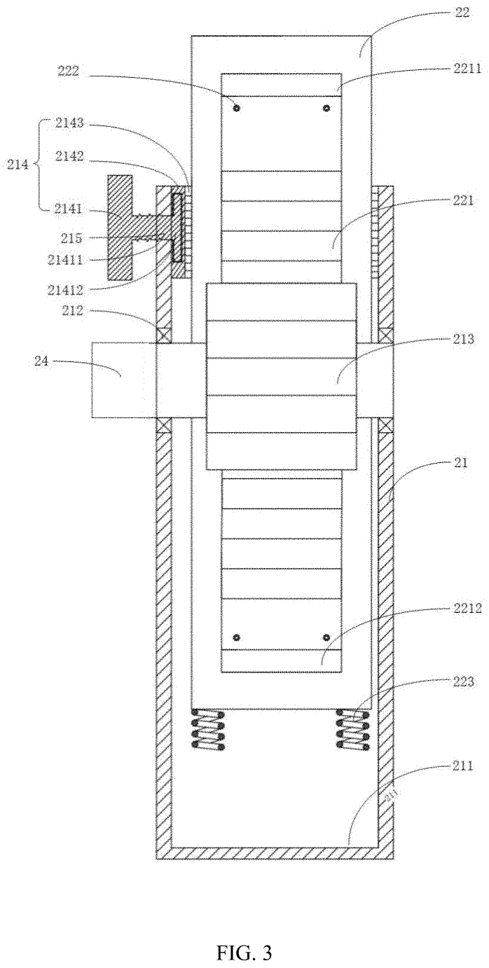

With respect to the height adjusting unit 20, referring to FIG. 1 and FIG. 3, the height adjusting unit 20 includes a first adjusting frame 21, a second adjusting frame 22, a support frame 23, and a first motor 24. The second adjusting frame 22 is sleeved to the first adjusting frame 21, the second adjusting frame 22 is movable relative to the first adjusting frame 21, the first adjusting frame 21 is connected to the projecting unit 10, the second adjusting frame 22 is connected to the support frame 23, the support frame 23 is connected to the direction adjusting unit 30, and the first motor 24 is configured to drive the second adjusting frame 22 to move relative to the first adjusting frame 21.

With respect to the first adjusting frame 21, the first adjusting frame 21 is provided with a groove 211, wherein the groove 211 is configured to receive the second adjusting frame 22; and the first adjusting frame 21 is provided with a rotation shaft 212, wherein the rotation shaft 212 is rotatable relative to the first adjusting frame 21. A gear shaft of a gear 213 is inserted into the rotation shaft 212, and the gear shaft of the gear 213 is fixed to the rotation shaft 212.

With respect to the second adjusting frame 22, the second adjusting frame 22 is provided with a rack 221. In some embodiments, the rack 221 is fixed to an inner surface of the second adjusting frame 22 via at least one screw 222, received in the groove 211, and movable along a lengthwise direction (that is, along a length of the first adjusting frame 21) of the groove 211. The gear 213 is in mesh with the rack 221.

With respect to the first motor 24, the first motor 24 is disposed on the first adjusting frame 21, connected to the rotation shaft 212, and configured to drive the rotation shaft 212 to rotate, such that the gear 213 is driven to rotate. The rotation of the gear 213 drives the rack 221 to move along the lengthwise direction of the first adjusting frame 21, such that relative positions of the first adjusting frame 21 and the second adjusting frame 22 are changed, a length of the height adjusting unit 20 is changed, and finally a height of the projection screen is adjusted.

In some embodiments, for facilitation of the movement of the second adjusting frame 22 relative to the first adjusting frame 21, the first adjusting frame 21 is further provided with a roller (not illustrated), wherein the roller is rotatably disposed in the groove 211, and the roller is abutted against a side of the second adjusting frame 22 far away from the rack 221. In the case that the second adjusting frame 22 is movable relative to the first adjusting frame 21, the roller may effectively reduce friction between the second adjusting frame 22 and the first adjusting frame 21. Therefore, it is convenient for the second adjusting frame 22 to move relative to the first adjusting frame 21.

In some embodiments, a first bump 2211 and a second bump 2212 are respectively disposed on two ends of the rack 221, and a first limiting block (not illustrated) and a second limiting block (not illustrated) are extended on the first adjusting frame 21 towards an interior of the groove 211; wherein the first limiting block and the second limiting block are spaced apart from each other, the first limiting block and the second limiting block are disposed on two sides of the rack, in the case that the rack 221 approaches to the groove 211, and the first bump 2211 is abutted against the first limiting block, an inward retract stroke of the rack 221 reaches a maximum value, and in the case that the second bump 2212 is abutted against the second limiting block, an extend stroke of the rack reaches a maximum value. Alternatively, the first bump 2211, the second bump 2212, the first limiting block, and the second limiting block are configured to limit the stroke of the rack 221.

In some embodiments, at least one elastic member 223 is disposed at a lower end of the second adjusting frame 22. In the case that the second adjusting frame 22 is lowered to a height, the other end of the elastic element 223 is abutted against a surface of the groove 211 facing the second adjusting frame 22. With such configurations, the projection device 1 is prevented from being damaged in the case that the second adjusting frame 22 is descended too fast.

It is understandable that the driving of the gear 213 is not limited to the use of a motor, as long as the rotation of the gear 213 is achieved, such as a hand wheel drive, or the like. The connection between the rack 221 and the second adjusting frame 22 is not limited to the use of at least one screw 222, as long as the rack 221 may be fixed on the inner surface of the second adjusting frame 22, such as welding, or the like. The height adjusting unit 20 is not limited to this structure, and may also have other structures. For example, an air cylinder is used to push the second adjusting frame 22 to move relative to the first adjusting frame 21.

In some embodiments, the height adjusting unit 20 further includes a fixing assembly 214, and the first adjusting frame 21 is provided with a through hole 215; wherein the through hole 215 is in communication with the groove 211, and the fixing assembly 214 is inserted into the through hole 215 and is abutted against an outer surface of the second adjusting frame 22. The fixing assembly 214 is configured to fix the relative positions of the first adjusting frame 21 and the second adjusting frame 22 to finally fix the height of the projection screen.

With respect to the fixing assembly 214, the fixing assembly 214 includes a fixing threaded rod 2141, a fixing block 2142, and an anti-skid pad 2143. The fixing threaded rod 2141 is provided with an insertion portion 21411, wherein the insertion portion 21411 is inserted into the through hole 215, and the fixing threaded rod 2141 is provided with a connection portion 21412. The fixing block 2142 is movably connected to the fixing threaded rod 2141 via the connection portion 21412 and the fixing block 2142 is tightly abutted against the anti-skid pad 2143, and the anti-skid pad 2143 is tightly abutted against the outer surface of the second adjusting frame 22. Friction resistance between the fixing block 2142, the anti-skid pad 2143, and the second adjusting frame 22 may be increased by tightening the fixing threaded rod 2141, thereby fixing the position of the second adjusting frame 22.

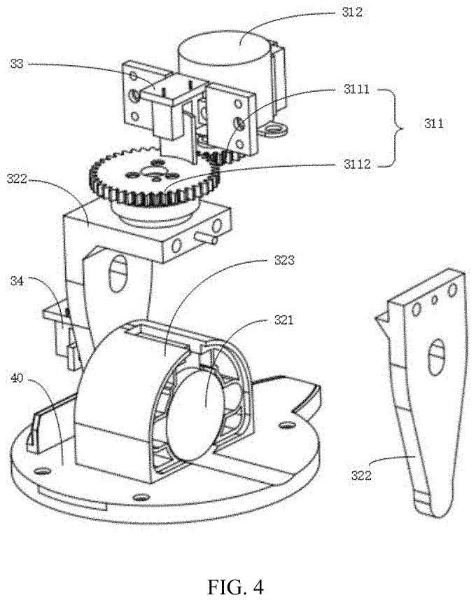

With respect to the direction adjusting unit 30, referring to FIG. 2 and FIG. 4 again, the direction adjusting unit 30 includes: a first rotation assembly 31 and a second rotation assembly 32. The first rotation assembly 31 is fixed to the other end of the height adjusting unit 20; and the second rotation assembly 32 is fixed to the first rotation assembly 31, wherein the reflecting unit 40 is fixed to the second rotation assembly 32, the first rotation assembly 31 is configured to drive the second rotation assembly 32 to rotate in a first direction, and the second rotation assembly 32 is configured to drive the reflecting unit 40 to rotate in a second direction, wherein the first direction is different from the second direction.

In an embodiment of the present disclosure, the first direction is a yaw angle, and the second direction is a pitch angle. In some other embodiments, the first direction and the second direction may be two directions perpendicular to each other, or two directions that are not perpendicular to each other but different from each other, and may be set according to actual needs, which is not limited to the description in the embodiments of the present disclosure.

With respect to the first rotation assembly 31, the first rotation assembly 31 includes a driven gear 3111, a driving gear 3112, and a second motor 312; wherein the second motor 312 is fixed to the support frame 23, and a rotation shaft of the second motor 312 is fixed to the driving gear 3112; the driving gear 3112 is in mesh with the driven gear 3111; and the second rotation assembly 32 is fixed to the driven gear 3111. The driven gear 3111 and the driving gear 3112 form a gear reduction box 311. The second motor 312 drives the gear reduction box 311, such that the second rotation assembly 32 fixed to the driven gear 3111 rotates about a central axis of the driven gear 3111.

With respect to the second rotation assembly 32, the second rotation assembly 32 includes a third motor 321 and a support arm 322. The support arm 322 is connected to the first rotation assembly 31, and is rotatable relative to the support frame 23, the support arm 322 is fixed to the driven gear 3111, and a rotation shaft of the third motor 321 is fixed to the support arm 322.

In some embodiments, the second motor 312 and the third motor 321 are also each provided with a motor winder to prevent the wire twisting in the case that an adjusting unit rotates.

In some embodiments, the second rotation assembly 32 includes a motor fixing frame 323; wherein the reflecting unit 40 is fixed to the motor fixing frame 323, the third motor 321 is fixed inside the motor fixing frame 323, the rotation shaft of the third motor 321 is extended out of the motor fixing frame 323, and the motor fixing frame 323 is rotatably connected to the other end of the support arm 322.

In an embodiment of the present disclosure, the third motor 321 rotates to drive the reflecting unit 40 fixed to the motor fixing frame 323 to rotate in the second direction.

In some embodiments, the projection device 1 further includes: a first position sensor 33, a second position sensor 34, and a controller (not illustrated), wherein the first position sensor 33 is fixed to the second motor 312, and the second position sensor 34 is fixed to the support arm 322.

The first position sensor 33 and the second position sensor 34 are angular displacement sensors, and further, may be capacitive sensors with high sensitivity to measure variations of angular displacement amounts of the first rotation assembly 31 and the second rotation assembly 32, which are sensing devices capable of converting the measured angular displacements caused by rotations of shaft into an electric signal based on capacitance variations.

The embodiments of the present disclosure provide the projection device 1. The projection device 1 includes: the projecting unit 10, the direction adjusting unit 30, and the reflecting unit 40. The projecting unit 10 is configured to emit a projection screen; the reflecting unit 40 is configured to reflect the projection screen, and the reflecting unit 40 is fixed to the direction adjusting unit 30. The direction adjusting unit 30 is configured to adjust a reflection direction of the reflecting unit 40; and the height adjusting unit 20, wherein one end of the height adjusting unit 20 is connected to the projecting unit 10 and the other end of the height adjusting unit 20 is connected to the direction adjusting unit 30, a spacing between the reflecting unit 40 and the projecting unit 10 may be changed by changing a length of the height adjusting unit 20, thereby conveniently and accurately adjusting the height of the projection screen.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A projection device, comprising:
a projecting unit, configured to emit a projection screen;
a direction adjusting unit;
a reflecting unit, fixed to the direction adjusting unit, wherein the direction adjusting unit is configured to adjust a reflection direction of the reflecting unit; and
a height adjusting unit, wherein one end of the height adjusting unit is connected to the projecting unit and the other end of the height adjusting unit is connected to the direction adjusting unit, the height adjusting unit is configured to adjust a spacing between the reflecting unit and the projecting unit, and the reflecting unit is configured to reflect the projection screen emitted by the projecting unit.

2. The projection device according to claim 1, wherein
the height adjusting unit comprises a first adjusting frame, a second adjusting frame, a support frame, and a first motor;
wherein the first adjusting frame is provided with a groove, the groove being configured to receive the second adjusting frame, the second adjusting frame is movable relative to the first adjusting frame, the first adjusting frame is connected to the projecting unit, the second adjusting frame is connected to the support frame, the support frame is connected to the direction adjusting unit, the first adjusting frame is provided with a gear, the gear being rotatable relative to the first adjusting frame, the second adjusting frame is provided with a rack, the rack being movable along a lengthwise direction of the first adjusting frame, the gear being in mesh with the rack, the first motor is disposed on the first adjusting frame, and the first motor is configured to drive the gear to rotate.

3. The projection device according to claim 2, wherein the height adjusting unit further comprises a fixing assembly, and the first adjusting frame is provided with a through hole; wherein the through hole is in communication with the groove, and the fixing assembly is inserted into the through hole and is abutted against an outer surface of the second adjusting frame.

4. The projection device according to claim 3, wherein the fixing assembly comprises a fixing threaded rod, a fixing block, and an anti-skid pad; wherein the fixing threaded rod is provided with an insertion portion, the insertion portion being inserted into the through hole, the fixing threaded rod is provided with a connection portion, the fixing block is movably connected to the fixing threaded rod via the connection portion, the fixing block is tightly abutted against the anti-skid pad, and the anti-skid pad is tightly abutted against the outer surface of the second adjusting frame.

5. The projection device according to claim 2, wherein the rack is fixed to an inner surface of the second adjusting frame via at least one screw.

6. The projection device according to claim 2, wherein a first bump and a second bump are respectively disposed on two ends of the rack, and a first limiting block and a second limiting block are extended on the first adjusting frame towards an interior of the groove; wherein the first limiting block and the second limiting block are spaced apart from each other, the first limiting block and the second limiting block are disposed on two sides of the rack, the first bump is abutted against the first limiting block in the case that an inward retract stroke of the rack reaches a maximum value, and the second bump is abutted against the second limiting block in the case that an extend stroke of the rack reaches a maximum value.

7. The projection device according to claim 2, wherein the first adjusting frame is provided with a rotation shaft; wherein a gear shaft of the gear is inserted into the rotation shaft, the gear shaft of the gear is fixed to the rotation shaft, and the rotation shaft is connected to the first motor.

8. The projection device according to claim 2, wherein at least one elastic member is disposed at a lower end of the second adjusting frame.

9. The projection device according to claim 1, wherein the direction adjusting unit comprises:
a first rotation assembly, fixed to the other end of the height adjusting unit; and
a second rotation assembly, fixed to the first rotation assembly, wherein the reflecting unit is fixed to the second rotation assembly, the first rotation assembly is configured to drive the second rotation assembly to rotate in a first direction, and the second rotation assembly is configured to drive the reflecting unit to rotate in a second direction, the first direction being different from the second direction.
